(19) United States
(12) Patent Application Publication
(10) Pub. No.: US 2019/0179536 A1
(43) Pub. Date: Jun. 13, 2019

(54) PARTIAL SUCCESSFUL DATA DELIVERY IN A DATA STORAGE SYSTEM

(71) Applicant: INTERNATIONAL BUSINESS MACHINES CORPORATION, ARMONK, NY (US)

(72) Inventors: RAUL ESTRADA, PIMA, AZ (US); ITZHACK GOLDBERG, HADERA (IL); RICHARD HUTZLER, PIMA, AZ (US); NEIL SONDHI, VAC (HU)

(21) Appl. No.: 15/838,458

(22) Filed: Dec. 12, 2017

(51) Int. Cl. G06F 3/06; H04L 29/08

(52) U.S. Cl. CPC G06F 3/067; G06F 3/0655; G06F 3/061; H04L 67/1097

(57) ABSTRACT

In response to receiving a data storage access request from a host system, a controller of a data storage system communicates first data of the data storage access request with the host system via a communication link. The controller determines whether communication of the first data via the communication link passes a data integrity check. In response to determining that communication of the first data via the communication link passes the data integrity check, the controller transfers second data between a storage device of the data storage system and the host system, determines whether transfer of the second data between the storage device and host system is only partially successful, and in response to the controller determining that transfer of the second data between the storage device and host system is only partially successful, requests retransmission of only a subset of the second data that was not successfully transmitted.

### BACKGROUND OF THE INVENTION

This disclosure relates to data processing and data storage, and more specifically, to improving data transfer in data storage environments by supporting partial successful data delivery.

In general, cloud computing refers to a computational model in which processing, storage, and network resources, software, and data are accessible to remote host systems, where the details of the underlying information technology (IT) infrastructure providing such resources is transparent to consumers of cloud services. Cloud computing is facilitated by ease-of-access to remote computing websites (e.g., via the Internet or a private corporate network) and frequently takes the form of web-based resources, tools or applications that a cloud consumer can access and use through a web browser, as if the resources, tools or applications were a local program installed on a computer system of the cloud consumer. Commercial cloud implementations are generally expected to meet quality of service (QoS) requirements of cloud consumers, which may be specified in service level agreements (SLAs). In a typical cloud implementation, cloud consumers consume computational resources as a service and pay only for the resources used.

Adoption of cloud computing has been facilitated by the widespread utilization of virtualization, which is the creation of virtual (rather than actual) versions of computing resources, e.g., an operating system, a server, a storage device, network resources, etc. For example, a virtual machine (VM), also referred to as a logical partition (LPAR), is a software implementation of a physical machine (e.g., a computer system) that executes instructions like a physical machine. VMs can be categorized as system VMs or process VMs. A system VM provides a complete system platform that supports the execution of a complete operating system (OS), such as Windows, Linux, Android, etc., as well as its associated applications. A process VM, on the other hand, is usually designed to run a single program and support a single process. In either case, any application software running on the VM is limited to the resources and abstractions provided by that VM. Consequently, the actual resources provided by a common IT infrastructure can be efficiently managed and utilized through the deployment of multiple VMs, possibly from multiple different cloud computing customers. The virtualization of actual IT resources and management of VMs is typically provided by software referred to as a VM monitor (VMM) or hypervisor.

In a typical virtualized computing environment, VMs can communicate with each other and with physical entities in the IT infrastructure of the utility computing environment utilizing conventional networking protocols. As is known in the art, conventional networking protocols are commonly premised on the well-known seven layer Open Systems Interconnection (OSI) model, which includes (in ascending order) physical, data link, network, transport, session, presentation and application layers. VMs are enabled to communicate with other network entities as if the VMs were physical network elements through the substitution of a virtual network connection for the conventional physical layer connection.

In the current cloud computing environments in which data storage systems and host systems can be widely geographically and/or topologically distributed, the performance impact of failed data transfers is significant. In current asynchronous input/output (I/O) protocols, such as Small Computer System Interface (SCSI), any failure in a data transfer requires that a data request and its associated data transfer both be repeated.

### BRIEF SUMMARY

In at least one embodiment, in response to receiving a data storage access request from a host system, a controller of a data storage system communicates first data of the data storage access request with the host system via a communication link. The controller determines whether communication of the first data via the communication link passes a data integrity check. In response to determining that communication of the first data via the communication link passes the data integrity check, the controller transfers second data between a storage device of the data storage system and the host system, determines whether transfer of the second data between the storage device and host system is only partially successful, and in response to the controller determining that transfer of the second data between the storage device and host system is only partially successful, requests retransmission of only a subset of the second data that was not successfully transmitted.

### BRIEF DESCRIPTION OF THE SEVERAL VIEWS OF THE DRAWINGS

FIG. 1 is a high level block diagram of a data processing environment in accordance with one embodiment;

FIG. 2 depicts the layering of virtual and physical resources in the exemplary data processing environment of FIG. 1 in accordance with one embodiment;

FIG. 3 is a high level block diagram of exemplary data storage system in the data processing environment of FIG. 1;

FIG. 4 is a high level logical flowchart of an exemplary write operation in a data storage environment in accordance with one embodiment; and

FIG. 5 is a high level logical flowchart of an exemplary read operation in a data storage environment in accordance with one embodiment.

### DETAILED DESCRIPTION

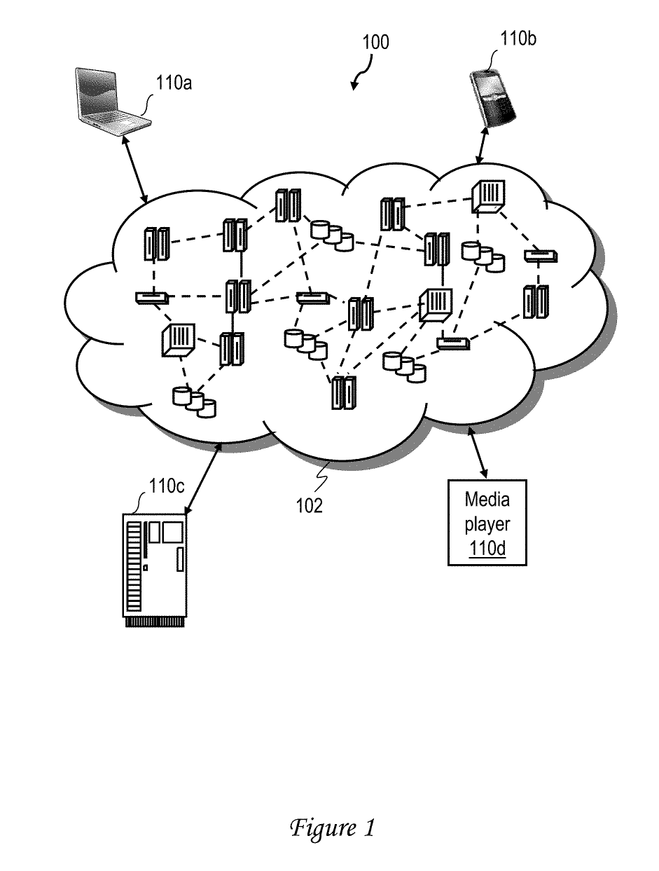

With reference now to the figures and with particular reference to FIG. 1, there is illustrated a high level block diagram of an exemplary data processing environment 100 in accordance within one embodiment. As shown, data processing environment 100, which in the depicted embodiment is a cloud computing environment, includes a collection of computing resources commonly referred to as a cloud 102. Computing resources within cloud 102 are interconnected for communication and may be grouped (not shown) physically or virtually, in one or more networks, such as private, community, public, or hybrid clouds or a combination thereof. In this manner, data processing environment 100 can offer infrastructure, platforms, and/or software as services accessible to host devices 110, such as personal (e.g., desktop, laptop, netbook, tablet or handheld) computers 110a, smart phones 110b, server computer systems 110c and consumer electronics, such as media players (e.g., set top boxes, digital versatile disk (DVD) players, or digital video recorders (DVRs)) 110d. It should be understood that the types of host devices 110 shown in FIG. 1 are illustrative only and that host devices 110 can be any type of electronic device capable of communicating with and accessing services of computing resources in collection 110 via a packet network.

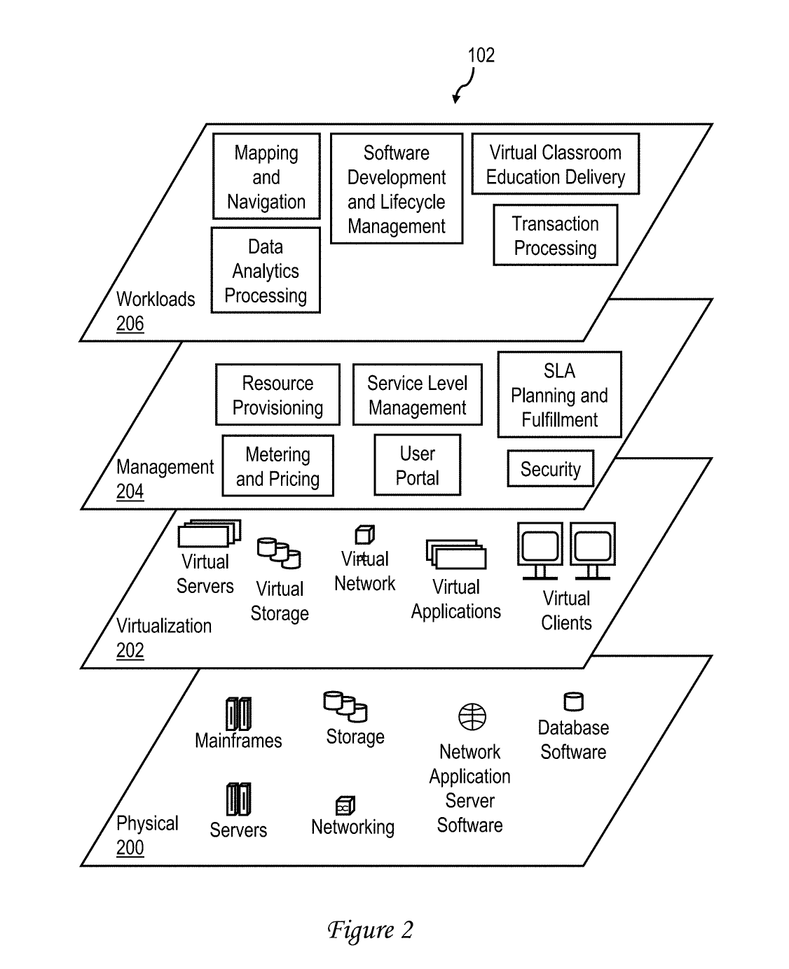

FIG. 2 is a layer diagram depicting exemplary virtual and physical resources residing in collection of cloud 102 of FIG. 1 in accordance with one embodiment. It should be understood that the computing resources, layers, and functions shown in FIG. 2 are intended to be illustrative only and embodiments of the claimed inventions are not limited thereto.

As depicted, cloud 102 includes a physical layer 200, a virtualization layer 202, a management layer 204, and a workloads layer 206. Physical layer 200 includes various physical hardware and software components that can be used to instantiate virtual entities for use by the cloud service provider and its customers. As an example, the hardware components may include mainframes (e.g., IBM® zSeries® systems), servers (e.g., IBM pSeries® systems), data storage systems (e.g., flash drives, magnetic drives, optical drives, tape drives, etc.), physical networks, and networking components (e.g., routers, switches, etc.). The software components may include, for example, operating system software (e.g., Windows, Linux, Android, iOS, etc.), network application server software (e.g., IBM WebSphere® application server software, which includes web server software), and database software.

The computing resources residing in physical layer 200 of cloud 102 are virtualized and managed by one or more virtual machine monitors (VMMs) or hypervisors. The VMMs present a virtualization layer 202 including virtual entities (e.g., virtual servers, virtual storage, virtual networks (including virtual private networks)), virtual applications, and virtual clients. As discussed previously, these virtual entities, which are abstractions of the underlying resources in physical layer 200, may be accessed by host devices 110 of cloud consumers on-demand.

The VMM(s) also support a management layer 204 that implements various management functions for the cloud 102. These management functions can be directly implemented by the VMM(s) and/or one or more management or service VMs running on the VMM(s) and may provide functions such as resource provisioning, metering and pricing, security, user portal services, service level management, and service level agreement (SLA) planning and fulfillment. The resource provisioning function provides dynamic procurement of computing resources and other resources that are utilized to perform tasks within the cloud computing environment. The metering and pricing function provides cost tracking (as resources are provisioned and utilized within the cloud computing environment) and billing or invoicing for consumption of the utilized resources. As one example, the utilized resources may include application software licenses. The security function provides identity verification for cloud consumers and tasks, as well as protection for data and other resources. The user portal function provides access to the cloud computing environment for consumers and system administrators. The service level management function provides cloud computing resource allocation and management such that required service levels are met. For example, the security function or service level management function may be configured to limit deployment/migration of a virtual machine (VM) image to geographical location indicated to be acceptable to a cloud consumer. The SLA planning and fulfillment function provides pre-arrangement for, and procurement of, cloud computing resources for which a future requirement is anticipated in accordance with an SLA.

Workloads layer 206, which may be implemented by one or more consumer VMs, provides examples of functionality for which the cloud computing environment may be utilized. Examples of workloads and functions which may be provided from workloads layer 206 include: mapping and navigation; software development and lifecycle management; virtual classroom education delivery; data analytics processing; and transaction processing. Of course, in other environments alternative or additional workloads may be executed.

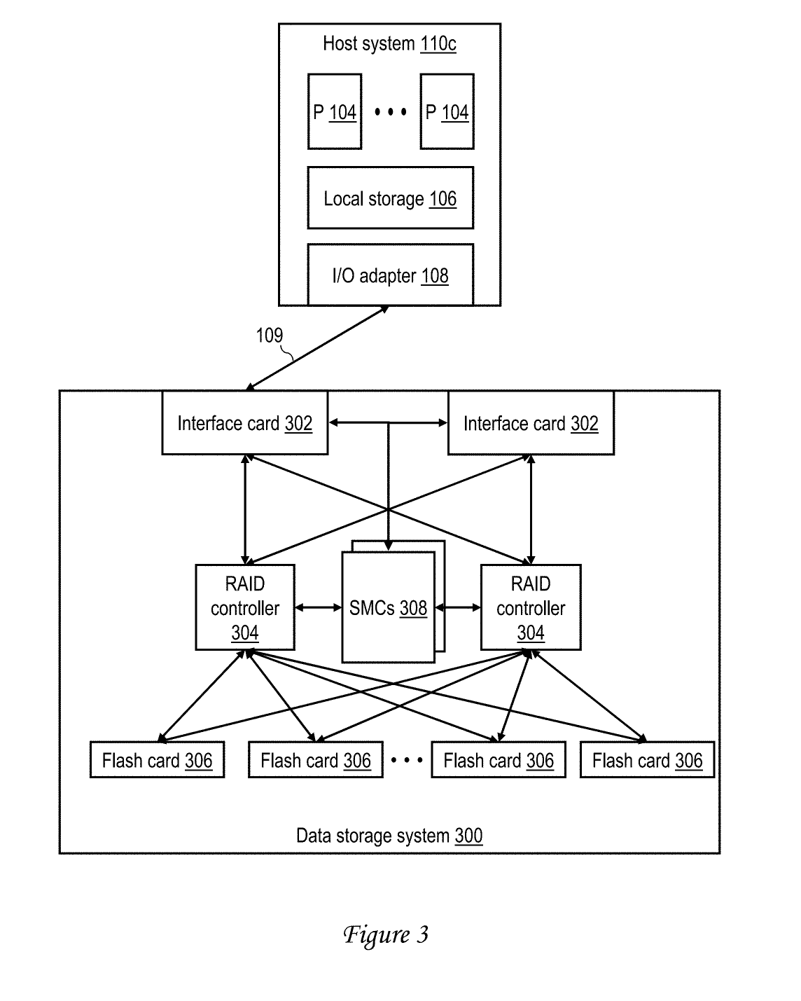

With reference now to FIG. 3, there is illustrated a high level block diagram of an exemplary data storage system 300 within cloud 102 of FIG. 1. As shown, data storage system 300 is coupled to one or more host systems 110, such as a host system 110c, via a communication link 109.

Exemplary host system 110c includes one or more processors 104 that process instructions and data and may additionally include local storage 106 (e.g., dynamic random access memory (DRAM) or disks) that stores program code, operands and/or execution results of the processing performed by processor(s) 104. Host system 110c further includes an input/output (I/O) adapter 108 that is coupled directly or indirectly to communication link 109. In various embodiments, communication link 109 may employ any one or a combination of known or future developed communication protocols, including, for example, Fibre Channel (FC), FC over Ethernet (FCoE), Internet Small Computer System Interface (iSCSI), InfiniBand, Transport Control Protocol/Internet Protocol (TCP/IP), Peripheral Component Interconnect Express (PCIe), Nonvolatile Memory Express (NVMe), NVMe over Fabrics, etc. I/O operations communicated via communication link 109 include read operations by which host system 110c requests data from data storage system 300 and write operations by which host system 110c requests storage of data in data storage system 300.

In the illustrated embodiment, data storage system 300 includes multiple interface cards 302 through which data storage system 300 receives and responds to input/output operations of hosts systems 110 received via communication links 109. Each interface card 302 is coupled to each of multiple Redundant Array of Inexpensive Disks (RAID) controllers 304 in order to facilitate fault tolerance and load balancing. Each of RAID controllers 304 is in turn coupled (e.g., by a PCIe bus) to one or more non-volatile storage devices 306, which in the illustrated example include multiple flash cards bearing NAND flash memory. In other embodiments, alternative and/or additional non-volatile storage devices can be employed.

In the depicted embodiment, the operation of data storage system 300 is managed by redundant system management controllers (SMCs) 308, which are coupled to interface cards 302 and RAID controllers 304. In various embodiments, system management controller 308 can be implemented utilizing hardware or hardware executing firmware and/or software.

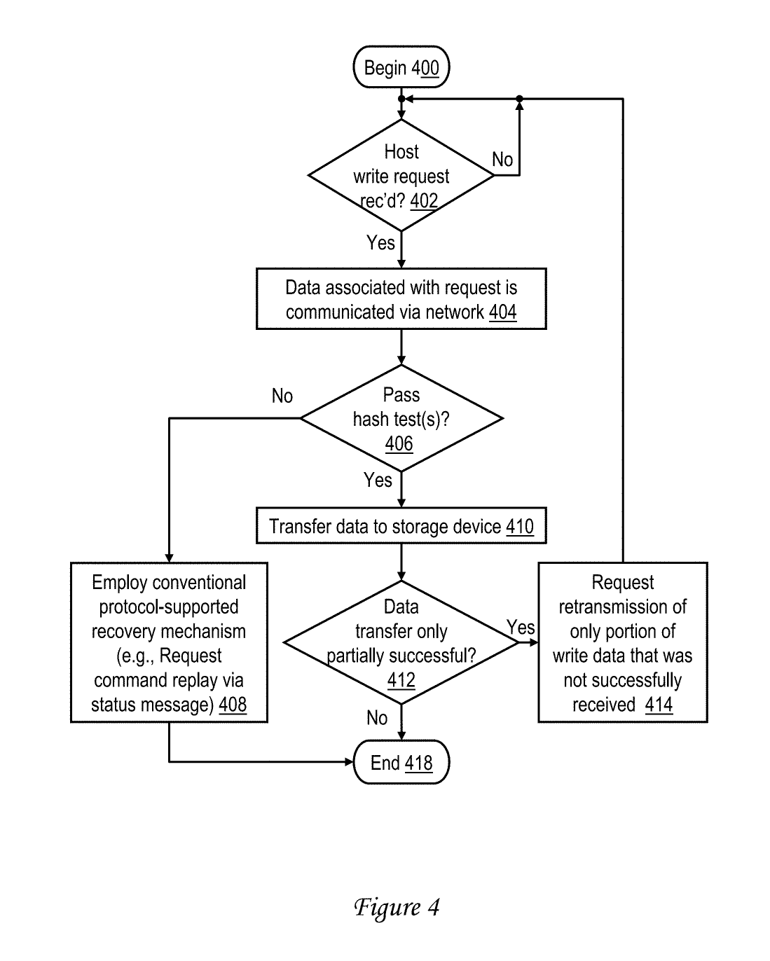

Referring now to FIG. 4, there is depicted a high level logical flowchart of an exemplary write operation in a data storage environment in accordance with one embodiment. The illustrated process is performed by a target device of an asynchronous I/O communication protocol. For ease of discussion, it will be assumed in the following discussion that the process is performed by a RAID controller 304 that communicates with an initiator (e.g., a host system 110) using the SCSI protocol (which may additionally employ iSCSI if implemented in an IP network). RAID controller 304 can implement the disclosed process in hardware, software, and/or firmware, or a combination thereof. Of course, in various implementations, the illustrated process may also be implemented by a different participant and/or using a different communication protocol. As one example, the communication of between the initiator and target can employ the multi-path I/O (MPIO) protocol in a storage area network (SAN) environment.

The process of FIG. 4 begins at block 400 and then proceeds to block 402, which depicts a RAID controller 304 of data storage system 300 awaiting receipt, via communication link 109, of a host write request (e.g., a SCSI write command) from a host system 110. As indicated at block 404, in conjunction with the host write request, RAID controller 304 also receives write data via communication link 109. Those skilled in the art will appreciate that the SCSI write command and its associated write data will be communicated in a plurality of protocol data units (PDUs), each including a header and data, and that these PDUs are unaligned with the underlying IP packets that encapsulate them. The integrity of the write data is conventionally protected by at least one protocol-dependent hash function (e.g., cyclic redundancy code (CRC)) that is computed by host system 110 from the write data and then appended to the write data to enable a recipient to verify receipt of an error-free or at least error-correctable copy of the write data.

In response to receipt of the write data, RAID controller 304 computes at least one hash of the write data and determines at block 406 whether or not the computed hash value matches that transmitted with the write data. For example, a hash value mismatch indicating data corruption can be caused by hardware and/or software errors in host system 110 or communication link 109, including a failure in an adapter 108, switch, router, Ethernet backbone, Fibre Channel link, etc. If a hash value mismatch is detected, the process passes from block 406 to block 408, which depicts RAID controller 304 employing a conventional protocol-specific recovery mechanism, which commonly includes RAID controller 304 requesting command replay, that is, retransmission of the entire host write request and associated data utilizing a protocol-specified status message. Those skilled in the art will appreciate, however, that the selected I/O protocol (e.g., SCSI), as well as the lower level protocols (e.g., TCP, IP, etc.) may support additional recovery mechanisms that enable retransmission of single PDUs (or other unit of transmission) prior to completion of the command. Following block 408, the process of FIG. 4 ends at block 418 until a next host write request is received.

Returning to block 406, in response to determining that the write data passed the hash test(s), RAID controller 304 transfers the write data to the target storage device 306 (block 410). Like the transfer via communication link 109, the data transmission of the write data from RAID controller 304 to the target storage device 306 is also subject to error, whether from cosmic radiation, transmission line effects, hardware and/or software failures, timeout errors, power glitches, intermittent storage device failures, etc. As a result, the transfer of the write data to the storage device may only be partially successful in that one or more PDUs of the write data may not be received by the storage device or may be corrupted when received. Given resource limitations, it may also not be possible for the RAID controller 304 to buffer all incoming data writes until successful transfer of the data to storage devices 306 is verified. It would be desirable, however, to not have to replay the entire command in such cases since the data transfer to the target storage device 306 was partially successful.

In accordance with one aspect of the disclosed inventions, the I/O protocol (which can otherwise be conventional) is extended so that the target storage device 306 is configured to review data transfers for partially successful data delivery and to notify an OS kernel (e.g., executing on RAID controller 304 or SMC 308) of a partially successful data delivery and an exact description of what data was not successfully transferred. With these extensions, the OS kernel can communicate that information to the user-level application to take corrective actions.

Accordingly, at block 412, the target storage device 306 determines whether the data transfer initiated at block 410 was only partially successful. The determination illustrated at block 412 may include, for example, a data integrity check, a sequence number check, and/or one or more alternative or additional checks to determine whether or not all write data was successfully received. In response to target storage device 306 determining at block 412 that the data transfer was fully successful, the requested write is complete. Accordingly, RAID controller 304 provides host system 110c any protocol-required status message to the initiator to conclude the command, and the process of FIG. 4 ends at block 418. If, however, the target storage device 306 determines at block 412 that the data transfer initiated at block 410 was only partially successful, the target storage device 306 notifies RAID controller 304, which in response in turn requests transmission from the host device 110 of only those PDUs of write data that were not successfully received (rather than all of the write data) (block 414). For example, RAID controller 304 may request transmission from the host device 110 of only those PDUs of write data that were not successfully received by providing a “partial success” status indicating the portion of the write data that was not successfully received. The “partial success” status automatically causes host system 110c to initiate transmission of another write request specifying only the write data (e.g., the specific PDUs) of the first write request that was not successfully received. Following block 414, the process returns to block 402 and following blocks, illustrating that the process of FIG. 4 is repeated by the target for the partial data delivered by the host system 110 in the second write request.

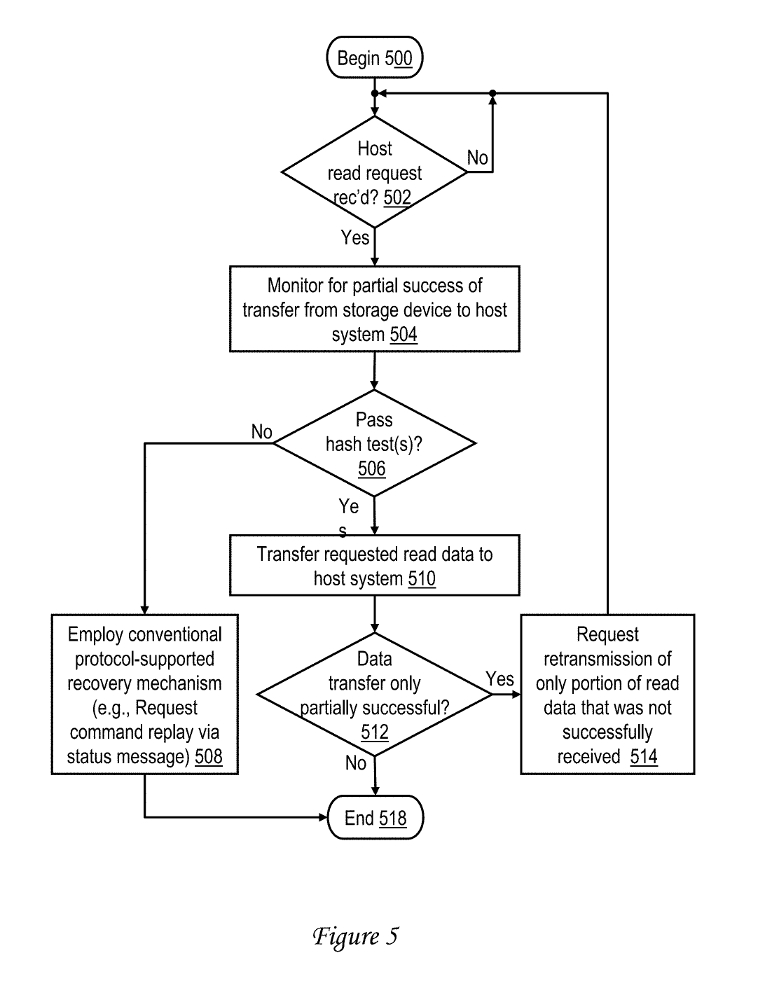

With reference now to FIG. 5, there is illustrated a high level logical flowchart of a read operation in a data storage environment in accordance with one embodiment. The illustrated process is performed by a target device of an asynchronous I/O communication protocol. For ease of discussion, it will again be assumed in the following discussion that the process is performed by a RAID controller 304 that communicates with an initiator (e.g., a host system 110) using the SCSI protocol (which may additionally employ iSCSI if implemented in an IP network). As noted above, RAID controller 304 can implement the disclosed process in hardware, software, and/or firmware, or a combination thereof. Of course, in various implementations, the illustrated process may also be implemented by a different participant and/or using a different communication protocol.

The process of FIG. 5 begins at block 500 and then proceeds to block 502, which depicts a RAID controller 304 of data storage system 300 awaiting receipt, via communication link 109, of a host read request (e.g., a SCSI read command) from a host system 110. In response to receipt of the host read request, RAID controller 304 monitors for partial success of a transfer of data from data storage to the requesting host system 110.

At block 506, RAID controller 304 computes at least one hash of the host read request received at block 502 and determines whether or not the computed hash value matches that transmitted with the read request. A hash value mismatch indicating data corruption can occur because of hardware and/or software errors in host system 110 or communication link 109, including a failure in an adapter 108, switch, router, Ethernet backbone, Fibre Channel link, etc. If a hash value mismatch is detected, the process passes from block 506 to block 508, which depicts RAID controller 304 employing a conventional protocol-specific recovery mechanism, which commonly includes RAID controller 304 requesting command replay, that is, retransmission of the entire host read request utilizing a protocol-specified status message. Those skilled in the art will appreciate, however, that the selected I/O protocol (e.g., SCSI), as well as the lower level protocols (e.g., TCP, IP, etc.) may support additional recovery mechanisms that enable retransmission of single PDUs (or other unit of transmission). Following block 508, the process of FIG. 5 ends at block 518 until a next host read request is received.

Returning to block 506, in response to determining that the host read request passed the hash test(s), RAID controller 304 accesses the requested read data from one or more data storage devices 306 and transfers the requested read data to the requesting host system 110 (block 510). Like the host read request, the transfer of the read data from the storage device(s) 306 to the requesting host system 110 is also subject to error, whether from cosmic radiation, transmission line effects, hardware and/or software failures, timeout errors, power glitches, intermittent storage device failures, etc. As a result, the transfer of the read data from the storage device(s) 306 to the requesting host system 110 may only be partially successful in that one or more PDUs of the read data may not be received by the requesting host system 110 or may be corrupted when received. It is desirable, however, to not have to replay the entire read command in such cases since the data transfer from the storage device(s) 306 to host system 110 was partially successful.

In accordance with one aspect of the disclosed inventions, the I/O protocol (which can otherwise be conventional) is extended so that RAID controller 304 and/or storage device(s) 306 is configured to detect partially successful data delivery and to notify an OS kernel (e.g., executing on RAID controller 304 or SMC 308) of a partially successful data delivery and an exact description of what data was not successfully transferred. With these extensions, the OS kernel can communicate that information to the user-level application to take corrective actions.

Accordingly, at block 512, the target system (e.g., RAID controller 304 and/or data storage device(s) 306) determines whether the data transfer initiated at block 510 was only partially successful. The determination illustrated at block 512 may include, for example, a data integrity check, a sequence number check, a check of a status returned by host system 110, and/or one or more alternative or additional checks to determine whether or not all write data was successfully received. In response to target system determining at block 512 that the data transfer was fully successful, the requested read operation is complete. Accordingly, RAID controller 304 provides host system 110c any protocol-required status message to the initiator to conclude the read command, and the process of FIG. 5 ends at block 518. If, however, the target system determines at block 512 that the data transfer initiated at block 510 was only partially successful, the target system requests retransmission from the host device 110 of only those PDUs of write data that were not successfully received (rather than all of the write data) (block 414). For example, RAID controller 304 may request transmission from the host device 110 of only those PDUs of write data that were not successfully received by providing a “partial success” status indicating the portion of the write data that was not successfully received. The “partial success” status automatically causes host system 110c to initiate transmission of a second read request specifying only the read data (e.g., the specific PDUs) of the first read request that was not successfully delivered. Following block 514, the process returns to block 502 and following blocks, illustrating that the process of FIG. 5 is repeated by the target system for the second read request.

As has been described, in at least one embodiment, in response to receiving a data storage access request from a host system, a controller of a data storage system communicates first data of the data storage access request with the host system via a communication link. The controller determines whether communication of the first data via the communication link passes a data integrity check. In response to determining that communication of the first data via the communication link passes the data integrity check, the controller transfers second data between a storage device of the data storage system and the host system, determines whether transfer of the second data between the storage device and host system is only partially successful, and in response to the controller determining that transfer of the second data between the storage device and host system is only partially successful, requests retransmission of only a subset of the second data that was not successfully transmitted.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the present invention has been particularly shown as described with reference to one or more preferred embodiments, it will be understood by those skilled in the art that various changes in form and detail may be made therein without departing from the spirit and scope of the invention. For example, although aspects have been described with respect to a data storage system including a flash controller that directs certain functions, it should be understood that present invention may alternatively be implemented as a program product including a storage device storing program code that can be processed by a processor to perform such functions or cause such functions to be performed. As employed herein, a “storage device” is specifically defined to include only statutory articles of manufacture and to exclude signal media per se, transitory propagating signals per se, and energy per se.

The figures described above and the written description of specific structures and functions below are not presented to limit the scope of what Applicants have invented or the scope of the appended claims. Rather, the figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms. Lastly, the use of a singular term, such as, but not limited to, “a” is not intended as limiting of the number of items.

What is claimed is:

1. A method of data communication between a data storage system and a host system, the method comprising:
in response to receiving a data storage access request from the host system, a controller of the data storage system communicating first data of the data storage access request with the host system via a communication link;
the controller determining whether communication of the first data via the communication link passes a data integrity check;
in response to determining that communication of the first data via the communication link passes the data integrity check:
the controller transferring second data between a storage device of the data storage system and the host system;
determining whether transfer of the second data between the storage device and host system is only partially successful; and
in response to the controller determining that transfer of the second data between the storage device and host system is only partially successful, the controller requesting retransmission of only a subset of the second data that was not successfully transmitted.

2. The method of claim 1, wherein:
the data storage access request is a write request; and
the second data is write data transmitted to the storage device.

3. The method of claim 1, wherein:
the data storage access request is a read request; and
the second data is read data requested by the host system.

4. The method of claim 1, wherein the communicating including communicating utilizing a small computer system interface (SCSI) protocol.

5. The method of claim 1, and further comprising:
in response to determining that communication of the first data via the communication link does not pass the data integrity check, the controller requesting retransmission by the host system of at least the first data.

6. The method of claim 1, wherein the controller requesting retransmission includes the controller providing the host system with a partial success status.

7. A data storage system, comprising:
a controller for a non-volatile storage device, wherein the controller is configured to perform:
in response to receiving a data storage access request from a host system, communicating first data of the data storage access request with the host system via a communication link;
determining whether communication of the first data via the communication link passes a data integrity check;
in response to determining that communication of the first data via the communication link passes the data integrity check:
transferring second data between a storage device of the data storage system and the host system;
determining whether transfer of the second data between the storage device and host system is only partially successful; and
in response to determining that transfer of the second data between the storage device and host system is only partially successful, requesting retransmission of only a subset of the second data that was not successfully transmitted.

8. The data storage system of claim 7, wherein:
the data storage access request is a write request; and
the second data is write data transmitted to the storage device.

9. The data storage system of claim 7, wherein:
the data storage access request is a read request; and
the second data is read data requested by the host system.

10. The data storage system of claim 7, wherein the communicating including communicating utilizing a small computer system interface (SCSI) protocol.

11. The data storage system of claim 7, wherein the controller is further configured to perform:
in response to determining that communication of the first data via the communication link does not pass the data integrity check, requesting retransmission by the host system of at least the first data.

12. The data storage system of claim 7, wherein requesting retransmission includes the controller providing the host system with a partial success status.

13. The data storage system of claim 7, and further comprising the non-volatile storage device.

14. A computer program product, the computer program product comprising a computer readable storage medium having program instructions embodied therewith, the program instructions executable by a controller of a data storage system to cause the controller to perform:
in response to receiving a data storage access request from a host system, the controller communicating first data of the data storage access request with the host system via a communication link;
the controller determining whether communication of the first data via the communication link passes a data integrity check;
in response to determining that communication of the first data via the communication link passes the data integrity check:
the controller transferring second data between a storage device of the data storage system and the host system;
determining whether transfer of the second data between the storage device and host system is only partially successful; and
in response to the controller determining that transfer of second data between the storage device and host system is only partially successful, the controller requesting retransmission of only a subset of the second data that was not successfully transmitted.

15. The computer program product of claim 14, wherein:
the data storage access request is a write request; and
the second data is write data transmitted to the storage device.

16. The computer program product of claim 14, wherein:
the data storage access request is a read request; and
the second data is read data requested by the host system.

17. The computer program product of claim 14, wherein the communicating including communicating utilizing a small computer system interface (SCSI) protocol.

18. The computer program product of claim 14, wherein the program instructions are executable by the controller to cause the controller to perform:
in response to determining that communication of the first data via the communication link does not pass the data integrity check, the controller requesting retransmission by the host system of at least the first data.

19. The computer program product of claim 14, wherein the controller requesting retransmission includes the controller providing the host system with a partial success status.
